(19) United States
(12) Patent Application Publication
(10) Pub. No.: US 2004/0230526 A1
(43) Pub. Date: Nov. 18, 2004

(54) Payment control system and associated method for facilitating credit payments in the accounts payable environment

(76) Inventor: C. Todd Praisner, Austin, TX (US)

Correspondence Address: Brian W. Peterman, O'KEEFE, EGAN & PETERMAN, Building C, Suite 200, 1101 Capital of Texas Highway South, Austin, TX, 78746, US

(21) Appl. No.: 10/824,579

(22) Filed: Apr. 14, 2004

Related U.S. Application Data
(60) Provisional application No. 60/469,941, filed on May 13, 2003.

(51) Int. Cl. G06F 17/60

(52) U.S. Cl. 705/40; 705/30

(57) ABSTRACT

A payment control system and associated method are disclosed that streamline the accounts payable process in part by facilitating credit transactions for meeting accounts payable payment requirements. Customers send electronic payment information files from customer accounting systems to the payment control system, and the payment control system determines how to make payments. Payment information from two or more customers can be aggregated to improve efficiencies, and a database of payee information can be utilized to improve operations and payment analyses conducted by the payment control system. The payment control system thereby intelligently manages accounts payable payment requirements and facilitates credit transactions to meet those requirements.

### RELATED APPLICATIONS

This application claims priority to the following provisional application: Provisional Application Ser. No. 60/469,941, which was entitled “METHOD AND SYSTEM FOR PUSHING CREDIT PAYMENTS AS BUYER INITIATED TRANSACTIONS” and was filed on May 13, 2003.

### Technical Field of the Invention

This invention relates to transaction mechanisms and more particularly to transaction mechanisms for handling payments for accounts payable payment requirements. The invention also relates to management of such transactions.

### BACKGROUND

Accounts payable (A/P) operations within the corporate environment are often settled through direct payments to vendors or merchants. In other words, once an invoice has been approved for payment, an accounting department will often make payment to the merchant by paper check. This paper transaction is often inefficient and costly in terms of time and manpower required to manage the process. The process of generating the list of A/P payment requirements is typically called the accounts payable (A/P) run for the corporation. The nature of the data generated in any given A/P run depends upon the accounting software being utilized, as well as other configuration details. Although basic payee identity and amount information may be present in the A/P run data, different companies: can produce. substantially different data and use substantially different data formats as a result of their A/P runs.

Business-to-business payments, which make up a significant portion of A/P payment requirements, have remained largely unchanged since the advent of the paper check. Latest industry estimates indicate nine billion business-to-business checks are processed in the U.S. annually. Several alternatives to the paper check have been attempted over the last 20 years with limited success. Each new option presented has had both its promise and its limitations. For example, commercial credit cards had the promise of easy payment by multiple company payment agents via the credit card network, but were limited by buy-side control shortcomings, 1099 reporting data issues, and unpredictable sell-side resistance to interchange fees associated with credit card. EDI (Electronic Data Interchange) had the promise of two-way data flow and electronic payment, but the practical limitation of requiring both buyer and seller to change behavior and implement new systems. ACH (Automated Clearing House) had the promise of eliminating paper checks, but, unlike a check, which can be sent to anyone with no preparatory interaction, ACH requires a per-relationship exchange of financial account information and testing (often called a “pre-note”) before an actual transaction can occur. Each of these alternatives may be appropriate for a subset of organizational payment requirements, but no single option is typically appropriate for all payments. And no single option is compelling enough to supplant checks on its own. Finally, because checks actually get the job done and A/P departments are under increasing loads, there is little internal impetus within most paying organizations to undergo a significant process change to address the inefficiencies inherent in A/P payments accomplished through paper checks.

Efforts to streamline payment transactions for individuals and businesses, however, have not worked well within the traditional corporate accounts payable environment. VISA Commerce is one example initiative from VISA that allows companies to enter into bilateral agreements to make electronic payments between them using the credit card infrastructure. With VISA Commerce, however, both the buyer and seller must agree beforehand as to how these transactions will occur. Another effort to streamline payment operations from an individual perspective is on-line banking. With on-line banking, individuals can provide vendor information to their banks, and the banks can then provide payment to the vendors directly from the respective bank accounts. In addition, some banks offer electronic payment and invoicing with 'respect to certain vendors. Still further, on-line payment mechanisms now include payment options such as those provided by PayPal and CheckFree. With PayPal, individuals can sign up and designate personal bank accounts and credit cards to be used with their PayPal accounts. These individuals may then make payments and receive payments through PayPal to other PayPal account holders. With CheckFree, individuals having bank accounts can receive electronic bills from certain companies, such as utilities or credit card companies, and can pay these bills electronically.

With respect to company payment requirements, bank-offered controlled disbursement programs represent an effort that has been made in an attempt to streamline A/P operations. These controlled disbursement products have been aimed at providing some level of outsourcing for disbursements such as checks, ACH transactions, and wire transfers. These products often take a single file feed of payment instructions from a customer, with each payment designated by the customer as payable via check, ACH, or wire transfer. These payment instructions are then fulfilled according to a service fee schedule for each type of payment. Typical customers for existing controlled disbursement products tend to be either distributed customers that want to maintain centralized control of their check stock or customers that have sufficient volume of checks that outsourcing is of significant financial benefit.

With respect to ease of payment, credit cards or payment cards are relatively efficient. Credit card transactions are typically initiated by a merchant “swiping” a card from a card holder. This “swiping” event includes the merchant obtaining a credit card number and verification information, and this transfer of information can occur in a number of different ways, including in person, over a telephone and through electronic communications. The merchant uses the credit card number and verification information to place the credit card transaction into the credit card transaction system. Merchants settle their credit card transactions using an acquiring bank that buys the merchants receipts for a percentage of their value. The acquiring bank then proceeds to collect payment from the credit card holder through the issuing bank. Typical credit card transactions and ultimate payment of the credit transaction, therefore, are based upon merchant initiated credit transactions.

Technical and institutional problems, therefore, currently exist with respect to streamlining payment procedures for corporations in the accounts payable environment. The traditional difficulty of using credit transactions, the lack of standardized data formats for A/P run payment information from current accounting systems, and the lack of automated systems for determining how to efficiently make payments to a wide variety of payees are just some of the problems faced in tackling efficiency problems with respect to A/P payment requirements.

### SUMMARY OF THE INVENTION

The present invention provides an intelligent payment control system and associated method that manages accounts payable (A/P) payment requirements and facilitates credit payments in the accounts payable environment. Customers send A/P run payment information to the payment control system, and the payment control system analyzes the information to determine an efficient and desirable solution for making required payments. This analysis can also be based upon information about payees, for example, from payee information stored in a database. In operation, the intelligent payment control system streamlines and improves the overall accounts payable process for one or more customers and acts to facilitate credit transactions to meet payment requirements. And customer payment requirements can be aggregated to further improve process efficiencies and advantages.

In one embodiment, the present invention is method for controlling payments to third-party entities, including receiving payment information in electronic form from at least one customer accounting system where the payment information includes a plurality of amounts to be paid to a plurality of third-party entities, analyzing the payment information to identify at least a subset of the third-party entities to pay through credit transactions, and initiating electronic credit transactions through a credit card processing system to make credit payments to the subset of third-party entities. In more detailed embodiments, the credit transactions can be based upon credit provided to an entity other than a customer. The payment information can include a plurality of different electronic payment information files from a plurality of different customers, and payments can be aggregated from the electronic payment information files. In addition, the electronic payment information files can utilize different data formats, and the electronic payment information files can be converted into a common data format for further processing. As described below, other features and variations can be implemented, if desired, and related systems can be utilized, as well.

In another embodiment, the present invention is a system for controlling payments to third- party entities, including a receiving module configured to receive electronic payment information from at least one customer accounting system where the electronic payment information includes a plurality of amounts to be paid to a plurality of third-party entities, a payment analysis module coupled to the receiving module where the payment analysis module is configured to identify a subset of third-party entities to pay through credit transactions, and a payment module configured to initiate electronic credit transactions through a credit card processing system to make credit payments to the subset of third-party entities. As indicated above, the payment information can include a plurality of different electronic payment information files from a plurality of different customers, and the electronic payment information files can utilize different data formats. In addition, the system can include a data parser that is configured to convert the electronic payment information files into a common data format. As described below, other features and variations can be implemented, if desired, and related methods can be utilized, as well.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 is a block diagram for an example payment control system environment, according to the present invention.

FIG. 2 is a flow diagram for an example payment control process, according to the present invention.

FIG. 3 is a block diagram for an example processing environment for a payment control system, according to the present invention.

FIG. 4 is a block diagram for an example account processing for a payment control system environment, according to the present invention.

### DETAILED DESCRIPTION OF THE INVENTION

The present invention provides an advantageous solution for enabling customers to streamline their accounts payable process by relying upon an automated payment control system that facilitates credit payments. Other payment mechanisms can also be utilized, if desired, such as paper check payments, direct ACH (automated clearing house) payments and/or other desired payment mechanisms.

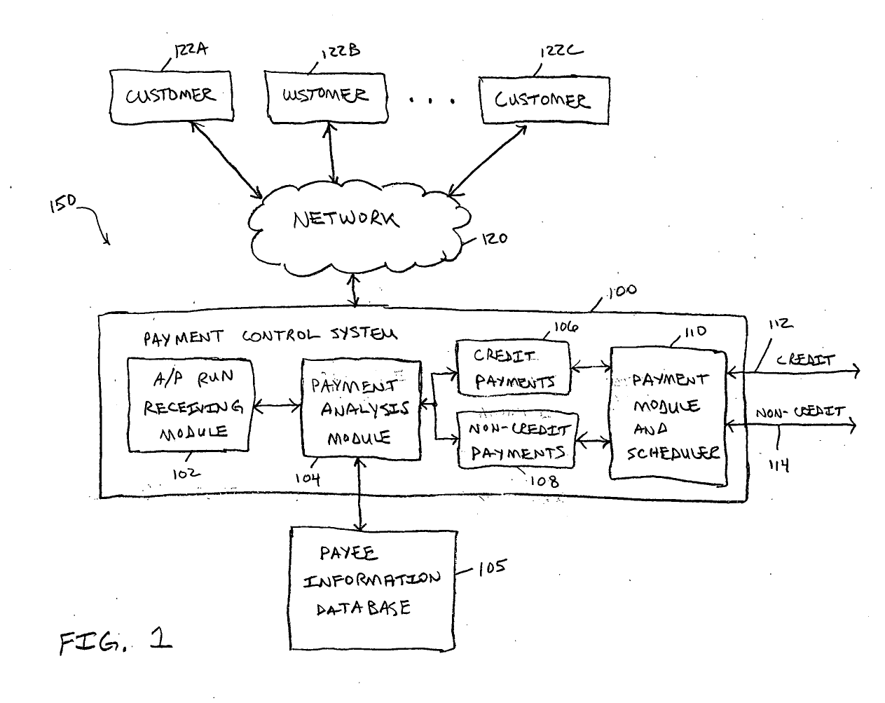

FIG. 1 is a block diagram for an example payment control system 100 that facilitates the use of credit transactions to satisfy accounts payable obligations for a plurality of customers 122A, 122B . . . 122C. In the embodiment 150 depicted, customers 122A, 122B . . . 122B are coupled to payment control system 100 through a network 120. The network 120 can include any of a wide variety of technologies for providing electronic communications between two or more systems. These communications, for example, may be made through any of a wide variety of devices for interconnecting computerized systems to each other through intranet or Internet networks, including wireless connections, network hubs, routers, Internet service providers (ISPs), portal computers, or any other device or system providing communication connectivity, as would be understood by one of skill in the art. It is noted that the network 120 is represented by a cloud shape to indicate that network 120 can include any desired communication medium that ultimately allows communication between customers 122A, 122B . . . 122C and the payment control system 100. The accounts payable (A/P) run receiving module 102 is configured to receive electronic accounts payable (A/P) information from customers 122A, 122B . . . 122C. This electronic A/P information can take a variety of forms depending upon the nature of the accounting software utilized by each individual customer 122A, 122B . . . 122C and depending upon how each customer decides to communicate A/P information to the payment control system 100. The A/P run receiving module 102 can include data parsers that operate to take customer data in disparate formats and convert this customer data into a common format for use by the payment control system 100. This A/P information can include data such as the payee identification, payment amounts, payment scheduling information, payment instructions or other accounts payable related information. If desired, the electronic A/P information can be stored in a database system or a storage system for delayed processing, or the electronic A/P information can be processed upon receipt by the payment control system 100. It is expected that the electronic A/P information received by the A/P run receiving module 102 will include a variety of different types of information. For example, for each payment item within the A/P run information received for each customer 122A, 122B . . . 122C, transmitted information would likely include at least the identity of the third party entity to be paid and the amount to be paid. TABLE 1 below provides an example list for basic A/P run information from two customers 122A and 122B.

TABLE 1
Example A/P Run Information

| Customer 122A | | | Customer 122B | | |
|---|---|---|---|---|---|
| Item | Payee | Amount | Item | Payee | Amount |
| 1 | XYZ Corp. | $1,250.00 | 1 | Office Supply Co. | $1,100.00 |
| 2 | ABC Corp. | $1,750.00 | 2 | XYZ Corp. | $3,200.00 |
| 3 | N&N Partners | $300.00 | 3 | ABC Corp. | $550.00 |
| . . . | . . . | . . . | . . . | . . . | . . . |

The payment analysis module 104 communicates with the A/P run receiving module 102 to receive A/P information related to one or more customers 122A, 122B . . . 122C. This A/P information can be processed separately for each individual customer, such as using a singie processing cycle for each customer 122A and 122B. If desired, the A/P information can also be processed in the aggregate by combining A/P information from two or more of the customers, such as using a single processing cycle to handle A/P information from customer 122A and customer 122B. The amount of aggregation and nature of the processing cycles can be determined by the payment control system 100 based upon a variety of factors, as desired, including the nature of the A/P information received, the number of customers, the identities of the third party entities to be paid, the amounts to be paid, and the timing of payment processing cycles. It is expected that transaction efficiencies will result from the aggregation of A/P payment requirements from all customers 122A, 122B . . . 122C and for the payment control system 100 to make payments in aggregate amounts to common payees. It is also noted that payment processing cycles may be conducted when desired and that certain periodic payment cycles, such as each night, could be utilized. In addition, the A/P information received from customers 122A, 122B . . . 122C may also include specific payment scheduling requirements that force payments to occur on certain days or at certain times, as instructed by the customers. The payee information database 105 holds payee information about third party entities, and this database 105 is preferably utilized by the payment analysis module 104 in determining how to make payments. The information stored in the database 105 can include any desired information about actual or potential payees, including what types of payment that will be accepted by each payee. TABLE 2 below provides basic example information that could be stored for payees concerning types of payment accepted by those payees.

TABLE 2
Payee Payment Information

| Payee | Credit | ACH | Check |
|---|---|---|---|
| ABC Corp. | YES | NO | YES |
| N&N Partners | NO | NO | YES |
| Office Supply Co. | NO | YES | YES |
| XYZ Corp. | YES | YES | YES |
| . . . | . . . | . . . | . . . |

The payment analysis module 104 is configured to intelligently analyze the A/P run information, such as set forth in TABLE 1, and the payee information, such as set forth in TABLE 2, to determine the most efficient and advantageous mechanisms to use in making payments that meet A/P payment requirements. In particular, the payment analysis module 104 preferably attempts to maximize credit transactions. As shown in the embodiment of FIG. 1, the payment analysis module 104 breaks payments into two basic categories. These categories are credit payments 106 and non-credit payments

For example, if the payment control system 100 were to receive the information in TABLE 1, to aggregate payments to be made, and to consult the payee information in TABLE 2, the resulting payments may be set to occur as follows: (1) credit payment of $4,450.00 to XYZ Corp., (2) credit payment of $2,300.00 to ABC Corp., (3) ACH payment of $1,100.00 to Office Supply Co., and (4) check payment of $300.00 to N&N Partners. As such, payments by customer 122A and customer 122B that would typically have been resolved by paper check transactions can now occur by more efficient and advantageous mechanisms. And more particularly, credit payments can be facilitated.

The payment module and scheduler 110 communicates with the payment analysis module 104 to receive the results of the payment analysis. In the embodiment depicted in FIG. 1, this payment analysis includes payments to be made as credit payments 106 and payments to be made as non-credit payments 108. The payment module and scheduler 110 then manages credit payment transactions 112 and non-credit payment transactions 114. And these payments can be scheduled and/or managed as desired to make efficient and/or advantageous timing of payments. Once payments are made, payment remittance information can be provided back to the customers 122A, 122B . . . 122C and payees 308 from the payment control system 100 through the network 120. This remittance information can include any desired level of detail, and other transaction related information may be provided as desired.

In operation, the payment control system 100 of the present invention can provide numerous advantageous for customers, particularly those that primarily use paper checks for accounts payable operations. For example, the A/P process for customers can remain essentially the same right up to the step of printing and signing checks. No new A/P processes are necessarily required for the customers. Customers can send A/P run data electronically to the payment control system 100, and the payment control system 100 can then automatically parse and process the data without requiring additional data processing from the customer. Modern accounting systems have a “Print to File” option for their A/P runs. As discussed above, the payment control system 100 can receive file-based output of the A/P run. And file or data parsers can be built for all common accounting system output formats, as well as any new, custom or other output formats encountered. In this way, the payment control system 100 is not required to interact synchronously with the customer accounting systems. The lack of this requirement is a significant advantage of the payment control system of the present invention.

In addition, the customers current A/P processes can be streamlined based upon industry practices, and disbursements by the payment control system 100 can occur according to customer configurable payment schedules thereby helping to optimize customer float on funds. In addition, customer policy-based controls provided through the payment control system 100 can allow for a variety of advantageous controls, such as payment review, payment approval, multi-signature control and other desired payment control features. Payments to be made by the payment control system 100 can also be controlled by the customers through hold, release or reschedule instructions, along with any other desired payment management instructions made available to customers. In addition, the payment control system 100 can communicate the status of payments to payees and customers through selected communication channels, such as e-mail, facsimile or web interface communications. Status information can include a variety of details, such as payment pending designations, payment transmitted notices, and payment receipt confirmation notices. The payment control system 100 can also include automated checkbook reconciliation (scheduled or on-demand) for customers that desire reconciliation features.

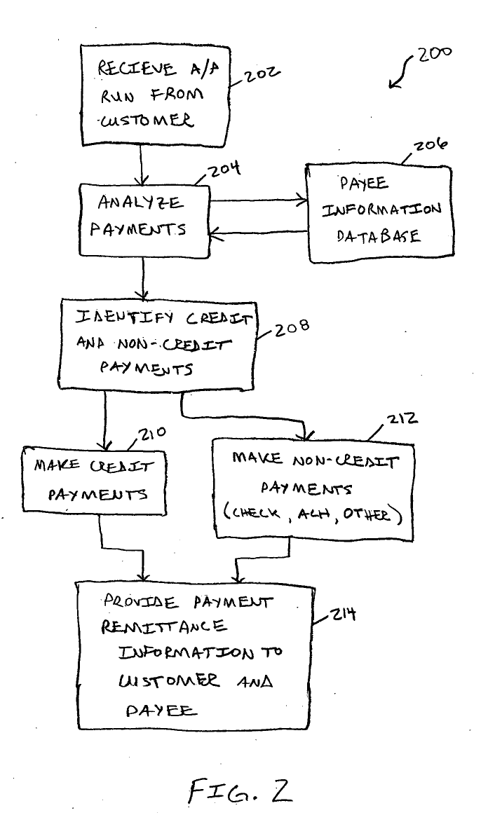

FIG. 2 is a flow diagram for an example payment control process 200, according to the present invention, in which potential payments are identified as credit transactions or non-credit transactions. In block 202, A/P run information is received from one or more customers. In block 204, the customer A/P payment requirements to payees are analyzed by the payment control system 100. In doing this analysis, a payee information database may be utilized as represented by block 206. In block 208, credit and non-credit payments are identified within the customer A/P payment requirements. In block 210, credit payments are made. In block 212, non-credit payments are made, such as check payments, ACH payments and/or payments made through other payment mechanisms. Finally, in block 214, payment remittance information is provided back to the one or more customers and one or more payees for which the payment control system is processing A/P run payment requirements.

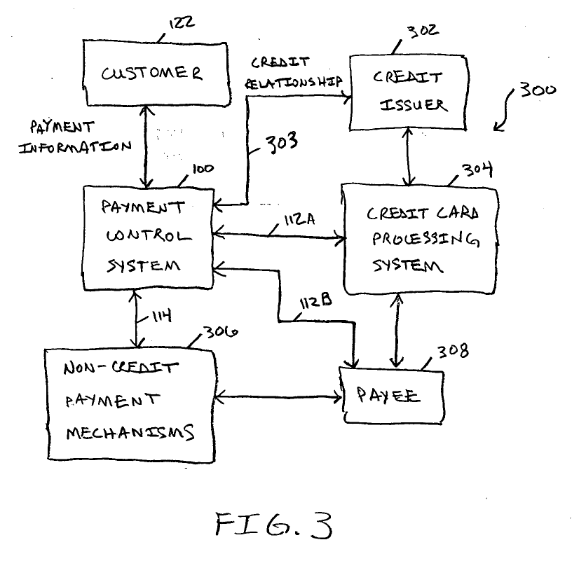

FIG. 3 is a block diagram for an example payment control system and related processing environment 300, according to the present invention. The embodiment depicted includes in part one or more customers 122, payment control system 100, credit issuer 302, and one or more payees 308. As discussed above, one or more customers 122 provide A/P payment information to the payment control system 100, and the payment control system analyzes this information and determines an optimal, efficient and/or advantageous payment solution for the payment requirements. The payment control system 100, for example, can use one or more credit relationships 303 with credit issuer 302 to make payments through credit transactions. For example, a single credit card could be utilized for all credit transactions; a different credit card for each payee could be utilized; a different credit card for each unique customer-payee combination could be utilized; or any other desired credit relationship structure could be utilized. Although a credit relationship between customers 122 and the credit issuer 302 could be utilized, it is preferable that the credit relationships be between the credit issuer 302 and the entity controlling the payment control system 100. In this latter implementation, the entity controlling the payment control system 100 is the credit holder. If the relationship is between the customer 122 and the credit issuer 302, the customer is the credit holder.

In the embodiment of FIG. 3, credit transactions are communicated through one or more transactions 112 to the credit card processing system 304. As discussed further below, transactions 112A represent buyer initiated or pushed credit payments, and transactions 112B represent merchant initiated credit payments. The credit card processing system 304 utilizes credit information from credit issuer 302 to make credit payments to one or more payees 308. Non-credit transactions are made through one or more transactions 114 that use non-credit payment mechanisms, as represented by block 306, to make payments to one or more payees 308.

Although a wide variety of payment mechanisms could be used, credit card payments are preferred due to the efficiency of their use and the advantages associated with the interchange points generated for use of credit cards to credit holders via rebate agreements with credit issuers, to credit issuers and/or to card processors. Traditional credit cards typically rely upon existing card processing infrastructures that include credit card networks, such as the VISA network, and card processors, such as Total System Services, Inc. (TSYS) and First Data Resources (FDR), which is a division of First Data Corporation. Card processors, such as these TSYS and FDR, typically store payment card control settings and process transactions made using payment cards according to these card control settings. The payment control system 100 can take advantage of this existing infrastructure and facilitate credit transactions that would typically be completed as check or ACH transactions. As stated above, paper check transactions are cumbersome, costly and inefficient. Although ACH transactions allow for direct account-to-account electronic transfers, ACH transactions require specific information transfers and approvals between parties for ACH transactions to be possible.

It is noted that the credit transactions 112 in FIG. 3 may be implemented in a variety of ways. For example, a credit transaction may be initiated by communicating the appropriate information to the payee and then having the payee charge or swipe the card. Transactions 112B represent these types of payee initiated credit payments. As one alternative, the credit transaction could also be initiated by pushing the credit payment through action by the customer or the payment control system 100. Transactions 112A represent these types of buyer initiated or pushed credit payments. A purchasing management system that in part facilitates the pushing of credit payments that do not have to be merchant or payee initiated is described with respect to co-owned U.S. Patent application Ser. No. ______, which was concurrently filed with the present application, and is entitled “METHOD AND SYSTEM FOR PUSHING CREDIT PAYMENTS AS BUYER INITIATED TRANSACTIONS,” the entire text and all contents for which is hereby expressly incorporated by reference in their entirety.

It is further noted that the payment control system 100 could be part of a broader payment management system that controls credit card spending and purchase authorization for companies. A purchasing management system that in part facilitates the use and management of payment cards for corporate purchasing needs is described with respect to co-owned U.S. patent application Ser. No. 10/083,445 ('445 Application) which was filed Oct. 19, 2001, and is entitled “DYNAMIC PAYMENT CARDS AND RELATED MANAGEMENT SYSTEMS AND ASSOCIATED METHODS,” the entire text and all contents for which is hereby expressly incorporated by reference in their entirety. The payment control system 100 of the present invention, therefore, could be included as an additional capability of such a purchasing management system.

With respect to merchant or payee initiated credit transactions 112B, the payee 308 will usually either manually swipe the card or enter the card identifying information provided with the payment information. Payment information can be provided to payees 308 through a variety of mechanisms. For example, the payment control system 100 can provide payee notification and a secure web interface through which payees can obtain card information related to the approved payments. After the initial payment with a particular credit card, some payees may keep the card information in their accounts receivable system for automated entry on future transactions. In addition, the amounts chargeable to any give credit card by a payee can be controlled through dynamic management of approval parameters. The '445 application identified describes a purchasing management system with these capabilities.

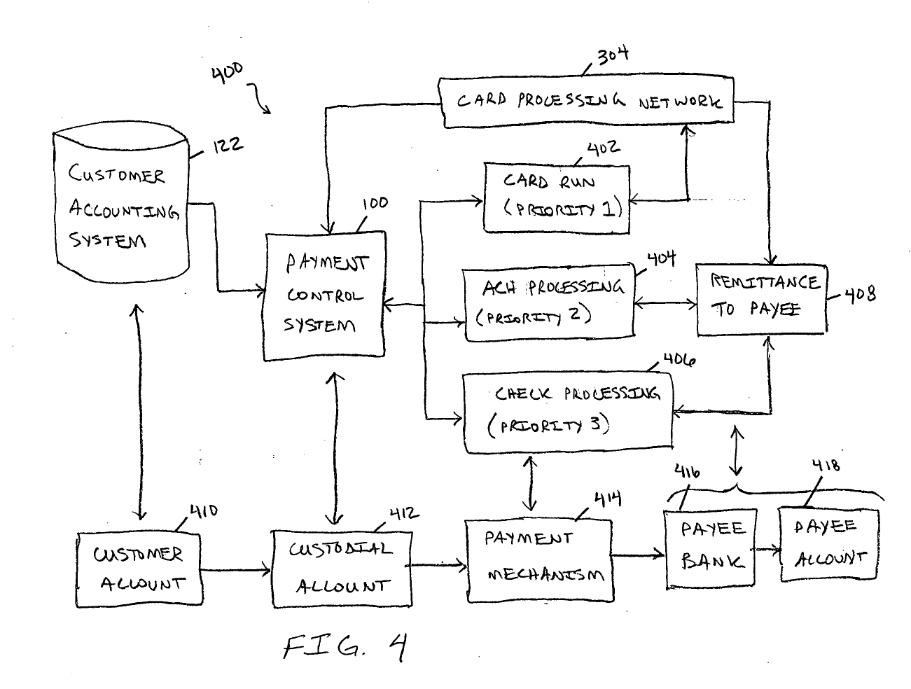

FIG. 4 is a block diagram for an example account processing environment 400 for a payment control system, according to the present invention. As discussed above, one or more customers 122 have customer accounting systems that provide accounts payable run information to the payment control system 100. The payment control system 100 then processes this information to determine the payment mechanisms to utilize in making payments to the identified third party entities or payees. In the embodiment 400 depicted, credit card transactions 402 are set as the first priority. ACH transactions 404 are set as the second priority. And check transactions 406 are set as the third priority. As depicted, credit transactions flow through the card run block 402 (Priority 1) to the card processing network 304. Information can then flow back to the payment control system 100, and remittance can be made to the payee, as represented by block 408. ACH transactions flow through ACH processing block 404 (Priority 2), and remittance is again made to payee in block 408. Check transactions flow through check processing block 406 (Priority 3), and remittance is made to payee in block 408.

The corresponding account processing for this payment processing is represented by blocks 410, 412, 414, 416 and 418. Initially, funds area present in the customer account 410. When payment information is sent to the payment control system 100 and processing is conducted by the payment control system 100, funds move from the customer account to the custodial account 412. As indicated above, the timing for this transfer from the customer account to the custodial account can be controlled by customer preferences and/or instructions, if desired. The next level in the transaction process is the operation of the payment mechanism, as represented by block 414, which itself does not typically involve the transfer of funds. Next, the payee bank 416 and finally the payee account 418 at that bank receive funds from the custodial account 412. This fund transfer process may be set at varying timings depending on the payment method. For example, the custodial account may be funded 1-2 days early for credit transactions, 3+days early for ACH payments, and 5+early days for paper check transactions.

As described herein, therefore, the payment control system 100 provides customers a mechanism for outsourcing traditional check payments in a way that tends to eliminate the need for significant A/P process changes for the customer organization, solves 1099 data reporting issues traditionally associated with credit card payments, and is profitable for the customers, banks and the operators of the payment control system. The payment control system 100 can take payment instructions in the form of standard A/P check-run files from a customer's accounting software and can move funds out of the customer's cash management account and into a bank-monitored custodial account for payment according to the customer's instructions. Advantageously, the exported check runs have already been pre-accounted for from a general ledger and 1099 perspective, two of the biggest process problems that have constrained commercial credit card use. The payment control system 100 then uses intelligent payment analyses with the help of a supplier or payee database to channel payments through a commercial card program, as a first priority. In the case where commercial card payment is not an option, ACH would be the next path priority. Finally, paper check would be the payment option of last resort. This priority of payment mechanisms is set forth in the embodiment depicted in FIG. 4. It is noted that other payment priorities could be implemented, if desired.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures described. For example, equivalent elements may be substituted for those illustrated and described herein, and certain features of the invention may be utilized independently of the use of other features, all as would be apparent to one skilled in the art after having the benefit of this description of the invention.

What is claimed is:

1. A method for controlling payments to third-party entities, comprising:
receiving payment information in electronic form from at least one customer accounting system, the payment information comprising a plurality of amounts to be paid to a plurality of third-party entities;
analyzing the payment information to identify at least a subset of the third-party entities to pay through credit transactions; and
initiating electronic credit transactions through a credit card processing system to make credit payments to the subset of third-party entities.

2. The method of claim 1, wherein the credit transactions are based upon credit provided to an entity other than a customer.

3. The method of claim 1, wherein the payment information comprises a plurality of different electronic payment information files from a plurality of different customers.

4. The method of claim 3, further comprising prior to initiating electronic credit payments, aggregating payments to at least one third-party entity common to a plurality of the electronic payment information files.

5. The method of claim 3, wherein the electronic payment information files utilize different data formats, and further comprising converting the electronic payment information files into a common data format.

6. The method of claim 1, further comprising storing information related to a plurality of third-party entities, the information including an identification of payment mechanisms through which the third-party entities will accept payment.

7. The method of claim 6, further comprising utilizing the stored information in the analyzing step to help determine the subset of third-party entities to pay through credit transactions.

8. The method of claim 1, wherein the initiating step comprises a credit holder initiating an electronic credit transaction through the credit card processing system.

9. The method of claim 1, wherein the initiating step comprises a payee initiating an electronic credit transaction through the credit card processing system.

10. The method of claim 1, wherein the receiving step further comprises receiving payment scheduling information from at least one customer.

11. The method of claim 1, further comprising initiating non-credit payments for third-party entities not within the subset of third-party entities for which credit transactions were initiated.

12. A system for controlling payments to third-party entities, comprising:
a receiving module configured to receive electronic payment information from at least one customer accounting system, the electronic payment information comprising a plurality of amounts to be paid to a plurality of third-party entities;
a payment analysis module coupled to the receiving module, the payment analysis module being configured to identify a subset of third-party entities to pay through credit transactions; and
a payment module configured to initiate electronic credit transactions through a credit card processing system to make credit payments to the subset of third-party entities.

13. The system of claim 12, wherein the credit transactions are based upon credit provided to an entity other than a customer.

14. The system of claim 12, wherein the payment information comprises a plurality of different electronic payment information files from a plurality of different customers.

15. The system of claim 14, wherein the payment analysis module is further configured to aggregate payments to at least one third-party common to a plurality of the electronic payment information files.

16. The system of claim 14, wherein the electronic payment information files utilize different data formats, and wherein the receiving module further comprises a data parser configured to convert the electronic payment information files into a common data format.

17. The system of claim 12, further comprising a database system configured to store information related to a plurality of third-party entities, the information including information related to payment mechanisms that are acceptable to the third-part entities.

18. The system of claim 17, wherein the payment analysis module is further configured to utilize the stored information to help determine the subset of third-party entities to pay through credit transactions.

19. The system of claim 12, further comprising a schedule module configured to manage timing of payments to third-party entities.

20. The system of claim 12, wherein the payment module is configured to initiate an electronic credit transaction through the credit card processing system as a credit holder initiated credit transaction.

21. The system of claim 12, wherein the payment module is configured to initiate an electronic credit transaction through the credit card processing system as a payee initiated credit transaction.

22. The system of claim 12, wherein the payment module is further configured to make non-credit payments for third-party entities not within the subset of third-party entities for which credit payments were initiated.
